(19) United States
(12) Patent Application Publication
(10) Pub. No.: US 2004/0238635 A1
(43) Pub. Date: Dec. 2, 2004

(54) Terminal device, service providing server, and RF tag sheet

(75) Inventors: Tomochika Ozaki, Yokohama (JP); Hiromichi Ito, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/770,785

(22) Filed: Feb. 2, 2004

(30) Foreign Application Priority Data
May 29, 2003 (JP) 2003-151789

(51) Int. Cl. G06K 7/08

(52) U.S. Cl. 235/451

(57) ABSTRACT

Services can be simply installed in a terminal. A terminal includes a radio frequency (RF) tag reader for reading identification information of an RF tag, a communicating unit for communicating with a server controlling services, a transmitter for transmitting by the communicating unit the identification information of the RF tag read by the RF tag reader to the server, a receiver for receiving, from the server, information regarding a service corresponding to the identification information of the RF tag. The terminal also includes an install function for installing therein a service according to service information received by the receiver. When the RF tag is within a readable range in which the terminal can read the RF tag, the terminal installs the service corresponding to the RF tag.

### BACKGROUND OF THE INVENTION

The present invention relates to a method of providing services to a terminal device and a device receiving the services.

In recent terminal devices highly developed in various points, functions necessary for the user can be incorporated therein later. Additional installation of functions is possible today naturally in personal computers and in devices such as a portable telephone and a personal digital assistant. It is therefore possible for the user to receive new services after purchase of such devices.

On the other hand, there exists a technique to make a check using a contactless integrated circuit card (IC card) to determine whether or not a user of the IC card can receive services. According to the technique, it is possible to use a portable certificate including a medium in the contour of a sheet and a contactless IC chip fixed onto the sheet.

Reference is to be made to, for example, patent article 1, namely, JP-A-2001-357377.

However, in the technique of the prior art, to use a new service, the user must install pertinent application using a predetermined procedure so that the device receives the service. These operations are troublesome for inexperienced users or beginners not fully accustomed to the device.

According to the technique using a contactless IC card, it is fully possible to determine whether or not the user of the IC card actually has the right to receive services. However, the technique cannot prepare environment to receive services.

### SUMMARY OF THE INVENTION

It is therefore an object of the present invention to prepare the environment for the user to receive services legitimately assigned to the user so that usability of the device is improved and services are easily distributed to the user.

To achieve the object according to the present invention, there are provided an integrated circuit called a radio frequency (RF) tag including a communicating unit to communicate with a terminal device or a terminal and an storage method to store an identification number (to be referred to as an identification number hereinbelow). The RF tag is arranged in a section of an adhesive sheet to be fixed onto a terminal, or the RF tag is arranged in a portion of a card to be inserted into a terminal or into a cover of the terminal.

According to the present invention, the terminal device includes an RF tag reader to read the RF tag. When the RF tag is fixed onto the terminal or when the card on which the RF tag is fixed is inserted in the terminal, the RF tag reader reads the identification number of the RF tag. According to the present invention, the terminal includes a communicating device to communicate with a server. The terminal sends the identification information of the RF tag thus read by the RF tag reader to the server.

According to the present invention, the server includes a service controller to control a correspondence between identification numbers of RF tags and services. The server also includes a communicating unit to communicate with a terminal so that the server receives an identification number of an RF tag from the terminal. When the RF tag identification number is received from the terminal, the service controller retrieves a service corresponding to the identification number. To the terminal, the server sends information (to be referred to as service information hereinbelow) necessary for the terminal to use the service determined as a result of the retrieval.

In operation of the terminal, when the communicating unit receives the service information from the server, the terminal installs an environment to use the service. The terminal includes an installed service controller to control a correspondence between the installed service and the RF tag identification number. The installed service controller also controls information necessary to uninstall the service installed in advance.

The terminal also includes an uninstall unit to terminates the use of the service. When an RF tag is removed or drawn from the terminal, the installed service controller retrieves a service corresponding to the RF tag to delete or uninstall the service according to the uninstall information controlled by the installed service controller.

Thanks to the constituent components according to the present invention, when an RF tag is fixed onto or is inserted into the terminal or the cover, the service corresponding to the RF tag can be used on the terminal. The use of the service is terminated when the RF tag is removed or drawn from the terminal.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a hardware configuration of a terminal device in an embodiment according to the present invention.

FIG. 2 is a block diagram showing a hardware configuration of an RF tag in an embodiment according to the present invention.

FIG. 3A is an explanatory diagram showing an example of an RF tag fixed onto a terminal device in an embodiment according to the present invention.

FIG. 3B is an explanatory diagram showing an example of an RF tag fixed onto a terminal device in an embodiment according to the present invention.

FIG. 4A is an explanatory diagram showing an example explicitly illustrating a place of the terminal in an embodiment according to the present invention in which the RF tag is fixed onto the place.

FIG. 4B is an explanatory diagram showing an example explicitly illustrating a place of the terminal in an embodiment according to the present invention in which the RF tag is fixed onto the place.

FIG. 5 is an explanatory diagram showing an example in which an RF tag on a card is inserted into the terminal in an embodiment according to the present invention.

FIG. 6 is an explanatory diagram showing a data configuration of a service control table in an embodiment according to the present invention.

FIG. 7 is an explanatory diagram showing an example of service information in an embodiment according to the present invention.

FIG. 8 is an explanatory diagram showing a data configuration of an installed service information control table in an embodiment according to the present invention.

FIG. 9 is a flowchart showing service install processing and service providing processing in an embodiment according to the present invention.

FIG. 10 is a diagram showing an example of an error display screen in an embodiment according to the present invention.

FIG. 11 is a flowchart showing service deleting processing in an embodiment according to the present invention.

FIG. 12 is a flowchart showing service adding/deleting processing in an embodiment according to the present invention.

FIG. 13 is an explanatory diagram showing examples of screens in an embodiment according to the present invention.

FIG. 14 is an explanatory diagram showing examples of screens in an embodiment according to the present invention.

FIG. 15 is an explanatory diagram showing examples of screens in an embodiment according to the present invention.

FIG. 16A is an explanatory diagram showing an example of count operation of a sheet including an RF tag in an embodiment according to the present invention.

FIG. 16B is an explanatory diagram showing an example of count operation of a sheet including an RF tag in an embodiment according to the present invention.

FIG. 16C is an explanatory diagram showing an example of count operation of a sheet including an RF tag in an embodiment according to the present invention.

FIG. 16D is an explanatory diagram showing an example of count operation of a sheet including an RF tag in an embodiment according to the present invention.

### DESCRIPTION OF THE EMBODIMENTS

Referring now to the drawings, description will be given of an embodiment according to the present invention.

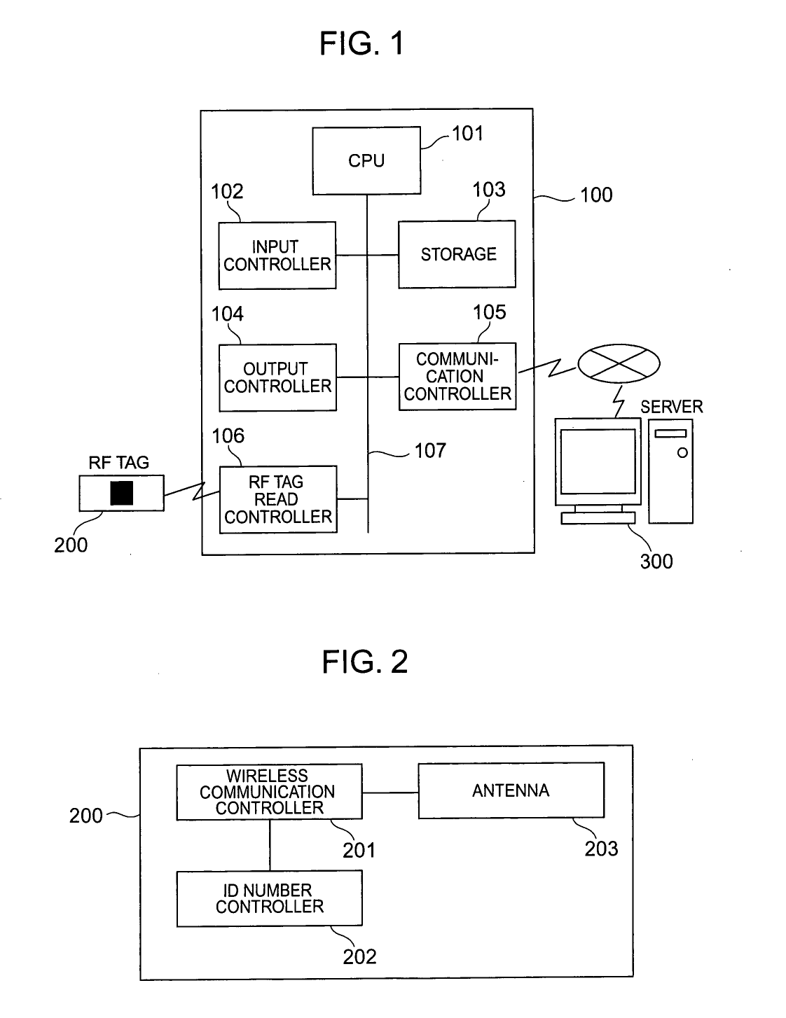

First, a terminal used in the present embodiment will be described by referring to FIG. 1.

FIG. 1 includes a terminal 100, for example, a portable telephone, a personal computer, a settop box, a digital camera, a handy camcoder, or a videotape recorder (VTR). Reference numeral 200 indicates an RF tag including an integrated circuit having a function for wireless communication. Reference numeral 300 is a server.

The terminal 100 includes constituent components 101 to 107. Numeral 101 indicates a central processing unit (CPU) which controls peripheral units and which executes various programs for data processing and communication. Numeral 102 is an input controller including constituent units such as a keypad, a touchpad, a ten-key unit, and various buttons. Numeral 103 is a storage, for example, a read only memory (ROM), a random access memory (RAM), a flash memory, or a hard disk. The storage 103 stores various programs and data used by the embodiment. Numeral 104 is an output controller including, for example, a liquid crystal display (LCD) and a driver to drive the LCD. The output controller 104 may be integrated in the terminal or separated therefrom. Numeral 105 is a communication controller to control communication with the server 300. The communication controller 105 controls protocols and physical layers of communication. The controller 105 may be a wireless or wired communication controller. Numeral 106 is an RF tag read controller to communicate with the RF tag and is used to obtain information from the RF tag.

Next, the RF tag will be described by referring to FIG. 2.

The RF tag includes a wireless communication controller 201, an identification number controller 202, and an antenna 203. The wireless communication controller 201 controls communication with the terminal 100. The identification number controller 202 records and keeps an identification number assigned to the RF tag 200. In general, mutually different identification numbers are assigned to the RF tags. However, there may be a case in which RF tags share one identification number. The antenna 203 is connected to the communication controller 201 to communicate radio signals therewith.

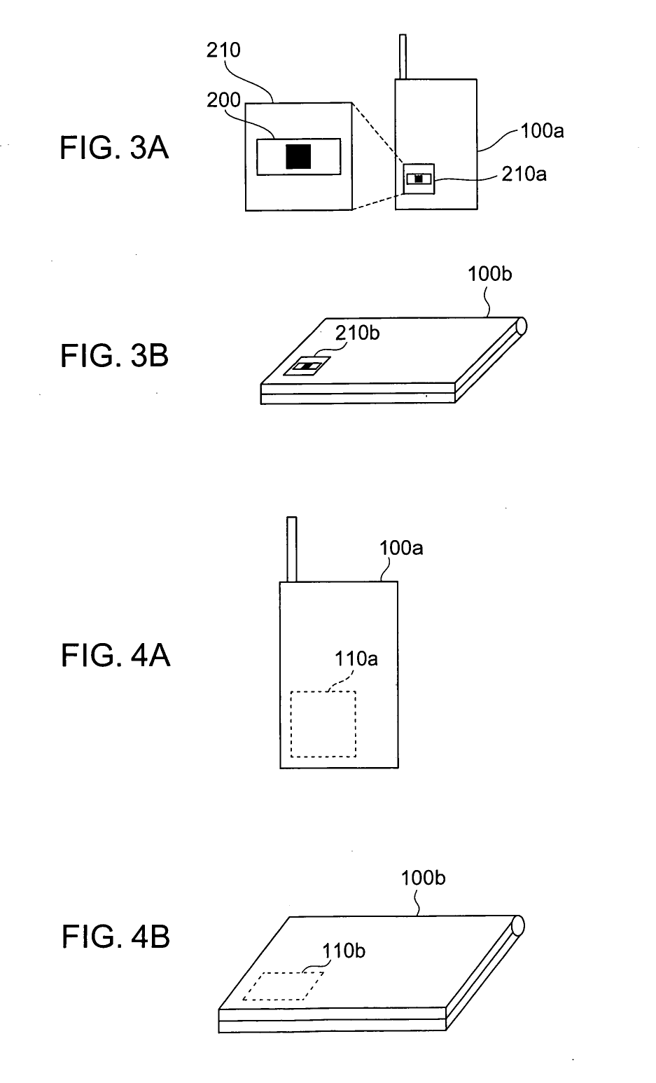

Next, an example of use of the RF tag 200 will be described by referring to FIGS. 3A, 3B, 4A, 4B, and 5.

FIGS. 3A and 3B show examples of the RF tag produced in the shape of a seal. In the examples, the RF tag 200 is arranged on a sheet 210 including an adhesive section so that the RF tag 200 is fixed onto the terminal 100. FIG. 3A shows an example in which a sheet 210a including the RF tag 200 is fixed onto a portable telephone 100a as an example of the terminal 100. FIG. 3B shows an example in which a sheet 210b including the RF tag 200 is fixed onto a personal computer 100b as an example of the terminal 100.

When it is desirable to clearly indicate or designate a place of the terminal 100 onto which the RF tag 200 is to be fixed, the pertinent place of the terminal 100 can be explicitly indicated. This possibly leads to an advantage of, for example, increase in sensitivity of the communication.

FIGS. 4A and 4B show examples indicating a place of the terminal 100 onto which the RF tag 200 is to be fixed. FIG. 4A is an example in which a place 110a of a portable telephone 100a as an example of the terminal 100 is indicated by a dotted line to fix the RF tag 200 onto the place 110a. FIG. 4B is an example in which a place 110b of a personal computer 100b as an example of the terminal 100 is indicated by a dotted line to fix the RF tag 200 onto the place 110b. Although a dotted line is used to indicate the place, any other line or any shape may be used to indicate the place onto which the RF tag is to be fixed.

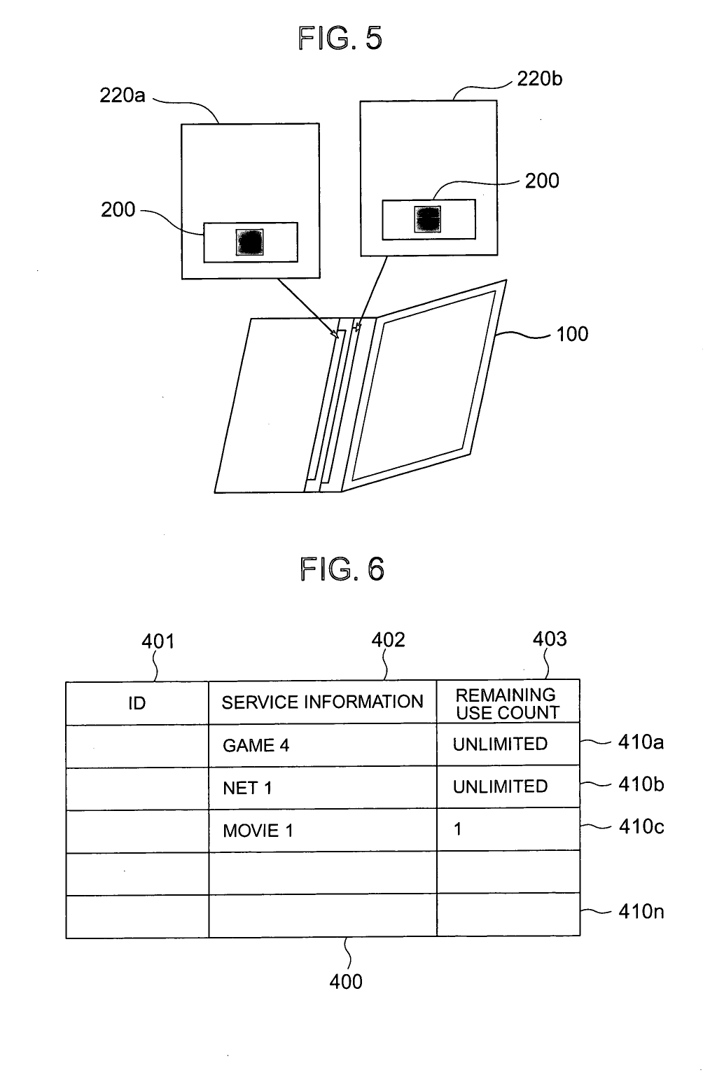

Next, FIG. 5 shows another example of use of the RF tag 200. In the example, the RF tag 200 is fixed onto a card 220, not onto a seal. In use, the card 220 is inserted into a card cabinet of the terminal 100. The card cabinet may be integrated in the terminal 100 or may be disposed in the cover of the terminal 100.

According to the present invention, when the seal 210 including the RF tag 200 is fixed onto the terminal 100 or the card 220 is inserted into the terminal 100, the user can receive an associated service using the terminal 100. Next, description will be given of data and processing to implement services.

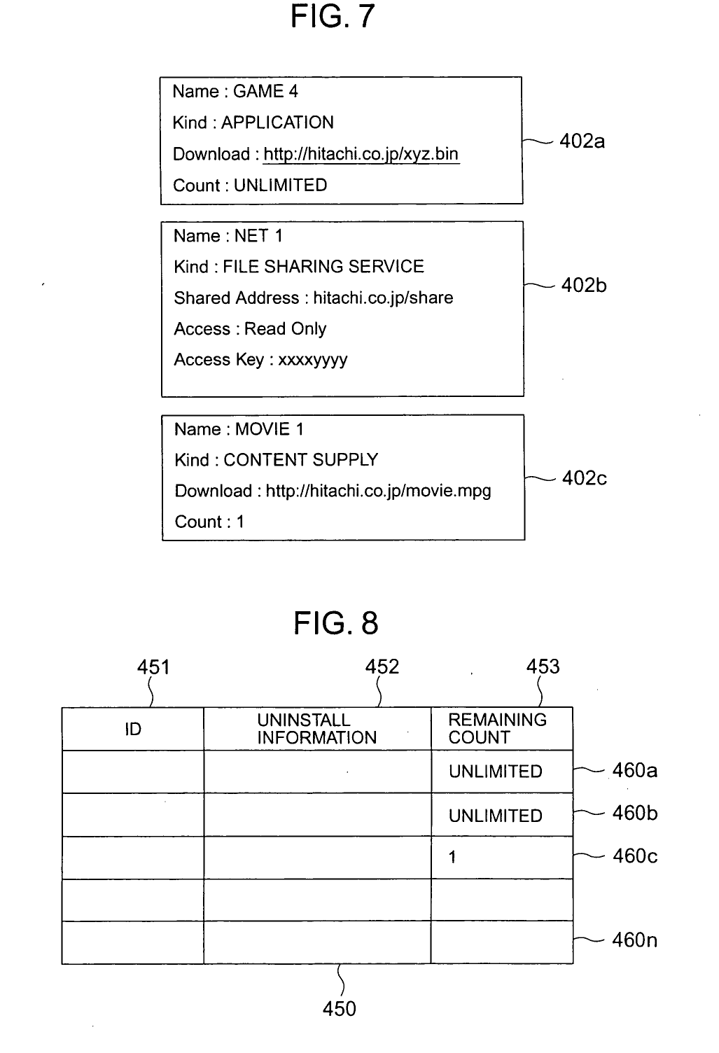

Referring now to FIGS. 6 and 7, description will be given of a service control table 400 to control a correspondence between identification numbers controlled by identification number controller 202 of RF tags 200 and services to be received. The server 300 controls the service control table 400.

The table 400 includes at least one service control record 410. Each record 410 includes an identifier 401, service information 402, and a remaining use count 403. The identifier 401 is an identification number controlled by the identification number controller 202 of the RF tag 200 and is information to identify the RF tag 200. The service information 402 is information regarding a service corresponding to the RF tag 200 identified by the identifier 401. The remaining use count 403 indicates how many times the user can receive the service associated with the identifier 401. This is a positive value or a symbol indicating that the user count is not restricted.

FIG. 7 shows an example of the service information.

Numeral 402 indicates an example when the service is application such as games. In this case, the service information 402 includes description of information items such as a service name (in a line of “name”), a service kind (in a line of “kind”), an application obtaining method (in a line of “download”), and an application use count (in a line of “count”).

In FIG. 7, numeral 402b indicates an example when the service is a file sharing service. In this case, the service information 402 includes description of information items such as a service name (in a line of “name”), a service kind (in a line of “kind”), an address of a file holder storing a shared file (in a line of “shared address”), an access right for the shared file (in a line of “access”), an access key to access the file (in a line of “access key”). The access right is, for example, a right only to read a file or a right to read and to write a file. The access key is, for example, a combination of a user identifier and a password.

In FIG. 7, numeral 402c indicates an example when the service is a content supply service to supply contents such as movies. In this case, the service information 402 includes description of information items such as a service name (in a line of “name”), service kind (in a line of “kind”), an address from which a content is obtained (in a line of “download”), and a content browse count (in a line of “count”).

The information items of FIG. 7 are shown only as examples of the service information. Therefore, all of the items are not required to be described. Even if other necessary information items are additionally specified for services, there does not occur any trouble or problem. In the example of FIG. 7, the information items for each service are described in the respective lines. However, the items may be naturally described, for example, in a description method of extensible markup language (XML).

Referring next to FIG. 8, description will be given of an installed service control table 450 to control an installed service installed in the terminal 100. The storage 103 of the terminal 100 stores the table 450.

The installed service control table 450 includes a plurality of installed service records 460. Each record 460 includes an identifier 451, uninstall information 452, and a remaining count 453.

The identifier 451 indicates an identification number controlled by the identification number controller 202 of the RF tag 200. The identifier 451 is an identifier to identify the RF tag 200. The uninstall information 452 is information required to uninstall a service corresponding to the RF tag 200 identified by the identifier 451. The remaining count 453 is a remaining count indicating how many times the user can receive the service associated with the RF tag 200 determined by the identifier 451.

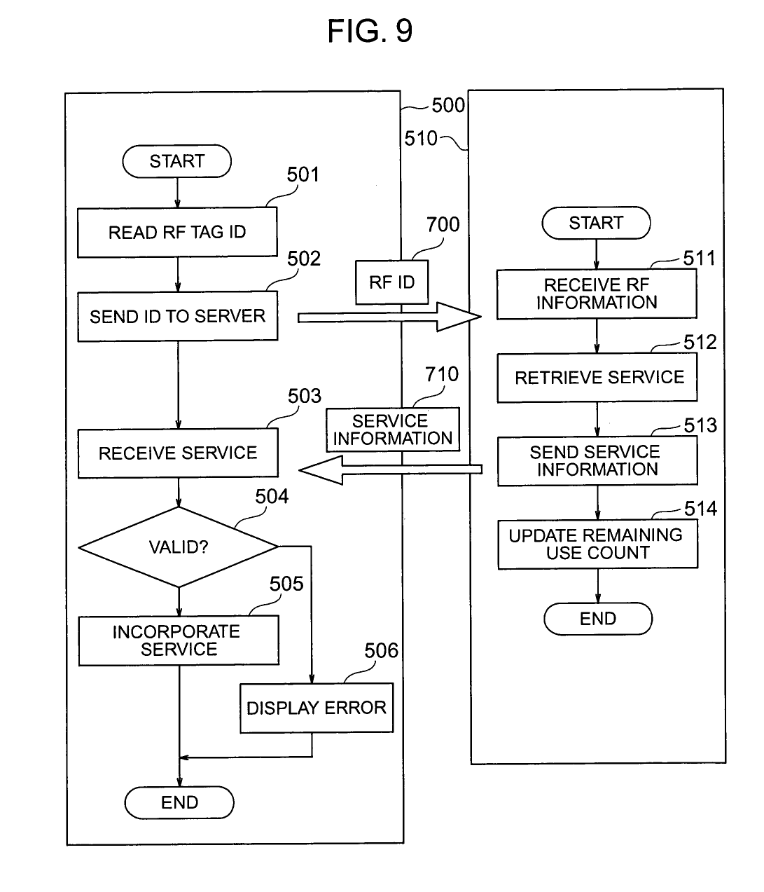

Referring now to FIG. 9, description will be given of service install processing 500 and service providing processing 510 which are executed when the terminal 100 detects a new RF tag 200. The terminal 100 executes the service install processing 500. The server 300 executes the service providing processing 510.

In the service install processing 500, the read controller 106 reads an identification number of the RF tag 200 from the RF tag (step 501). The identification number is then set to RF information data 700 to be sent to the server (step 502).

When the RF information data 700 is received, the server 300 executes the service providing processing 510. In the processing 510, an identification number of the RF tag 200 is obtained from the data 700 (step 511). A service control record 410 having an identification number of the identifier 401 equal to the identification number obtained in step 511 is then detected in the service control table 400. The service information 402 is read from the record 410 (step 512). Next, the service information 402 obtained in step 512 is set to service information data 710 to be sent to the terminal 100 (step 513). In step 512, if it is not possible to detect the service control record 410 or if the remaining use count 403 is “0” even when the record 410 is detected, an error code indicating an error is set to the service information data 710 in place of the service information 402. Next, when the remaining use count 403 of the service control record 410 determined in step 512 is a positive value, “one” is subtracted from the value (step 514). It is also possible to delete the service control record 410 from the service control table 400 when the remaining use count 403 is zero.

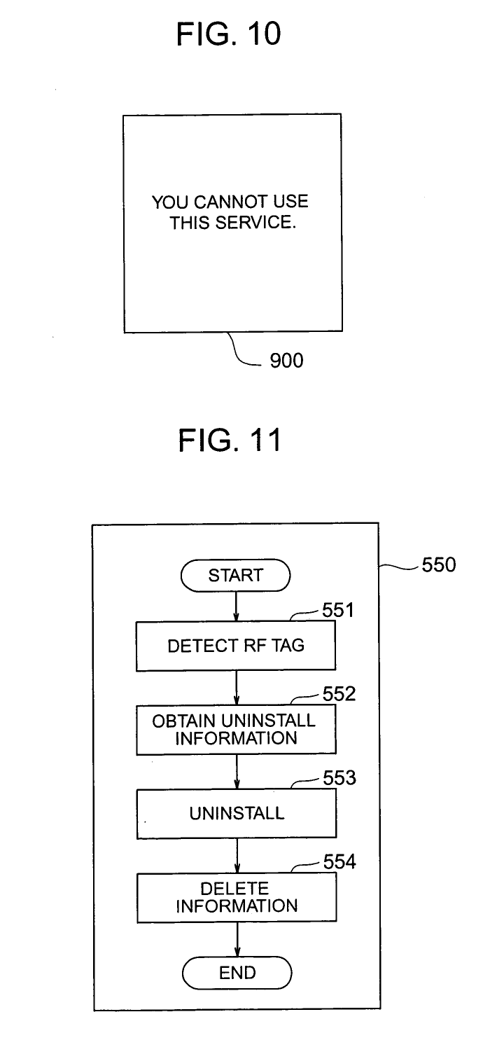

After step 502, the terminal 100 receives the service information 710 sent from the server 300 (step 503). A check is made to determine whether or not the service information 710 includes an error code (step 504). If such an error code is absent, a service is installed according to the information items of the service information. The terminal 100 then creates an installed service record 460 including an identifier 451 containing the identification number of the RF tag 200, uninstall information 452 containing information to uninstall the installed service, and a remaining count 453 containing a value of a use count limit if such a value is described in the service information 710. The terminal 100 then adds the installed service record 460 to the installed service control table 450 (step 505). When an error code is detected in the service information 710 in step 504, an event of the error is notified to the user (step 506). FIG. 10 shows an example of a screen image to notify an error to the user. There occurs no trouble even if the processing of step 506 is omitted.

If any particular processing is not required for the service uninstall operation, the uninstall information 452 is not necessary. If the service use count is not limited, the remaining count 453 is not necessary.

Each time the user receives the service, one is subtracted from the value of the remaining count 453. When the count 453 becomes zero, the user cannot receive the service.

Referring next to FIG. 11, description will be given of service uninstall processing 550 to be executed when the RF tag 200 fixed onto the terminal 100 is removed therefrom or when the RF tag 200 inserted into the terminal 100 is drawn therefrom. The terminal 100 executes the service uninstall processing 550.

In the processing 550, the RF tag 200 thus removed or drawn from the terminal 100 is checked for identification (step 551). This is achieved by, for example, comparing the identification information of the identifier 461 of the installed service record 460 in the installed service control table 450 with that of the RF tag 200 detected by the terminal 100. Next, the installed service record 460 corresponding to the RF tag determined in step 551 is identified to read uninstall information 452 therefrom (step 552). According to the uninstall information 452, the service is uninstalled (step 553). The installed service record 460 corresponding to the RF tag 200 determined in step 551 is then deleted from the installed service control table 450.

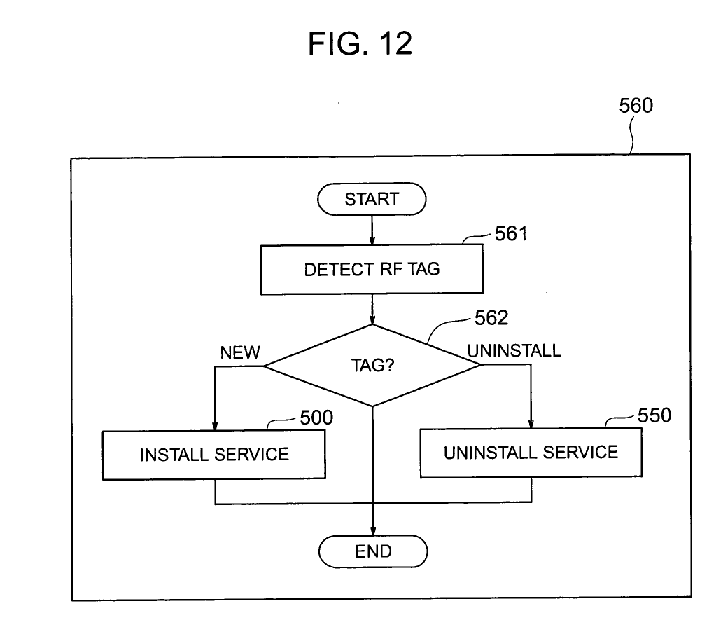

Detection of the addition and deletion of the RF tag 200 can be appropriately conducted, for example, at a periodic interval or when the terminal 100 is powered. Processing on such an occasion will be described by referring to FIG. 12.

Numeral 560 of FIG. 12 indicates the service install/uninstall processing. In the processing 560, the terminal 100 detects all available RF tags 200 and obtains an identification number of each tag (step 561). Identification information of the identifier 461 of the installed service record 460 in the installed service control table 450 is compared with that obtained in step 561 to determine presence or absence of an RF tag 200 added or deleted in advance (step 562). If such an RF tag 200 is absent, the processing is terminated. If an RF tag 200 has been added in advance, the service install processing 500 is executed. If an RF tag 200 has been deleted in advance, the service uninstall processing 550 is executed.

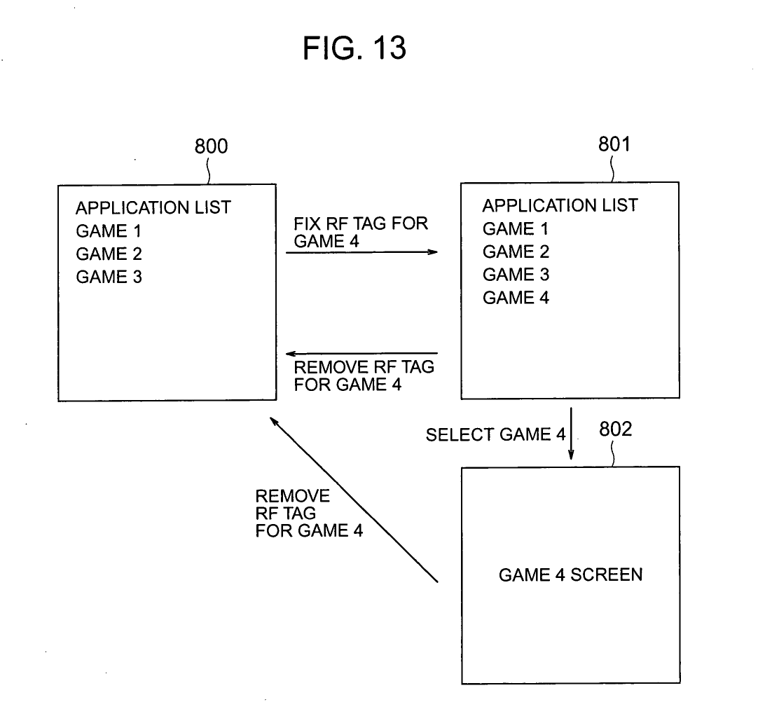

Referring now to FIGS. 13 to 15, description will be given of examples of services which can be achieved by use of the hardware, the data, and the processing described above.

FIG. 13 shows an example in which services corresponding to RF tags 200 are games. Numeral 800 is an example of a screen image of a list of games available before an RF tag 200 is fixed onto the terminal 100. When an RF tag 200 corresponding to a service of game 4 is fixed onto the terminal 100, game 4 becomes available. Numeral 801 shows an example of a screen image of a list of games available after the RF tag 200 is fixed onto the terminal 100. The user can play game 4 by selecting game 4 in the screen 801. When the RF tag 200 of game 4 is removed from the terminal 100, game 4 is uninstalled from the terminal 100. Therefore, the terminal 100 displays the screen image 800 not including game 4.

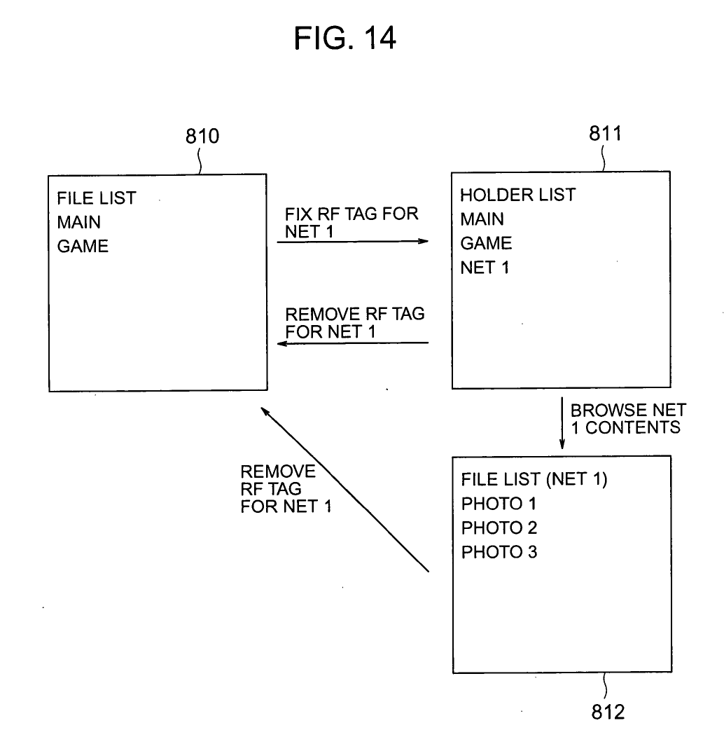

FIG. 14 shows an example in which the service corresponding to the RF tag 200 is a file sharing service. Numeral 810 is an example of a screen image of a list of holders available before an RF tag 200 is fixed onto the terminal 100. Assume that the service corresponding to an RF tag 200 is an access to a holder having a name of “net 1” on a server. When the RF tag 200 is fixed onto the terminal 100, it is possible to access the net 1. Numeral 811 shows an example of a screen image of a list of holders available after the RF tag 200 is fixed onto the terminal 100. By selecting “net 1”, the user can access a net 1 holder on the server. Numeral 812 shows an example of a screen image when the net 1 holder stores photos 1 to 3. When the RF tag 200 corresponding to the net 1 is removed from the terminal 100, the access to net 1 is uninstalled from the terminal 100. Therefore, the terminal 100 displays the screen image 810 not including the holder for the access to net 1.

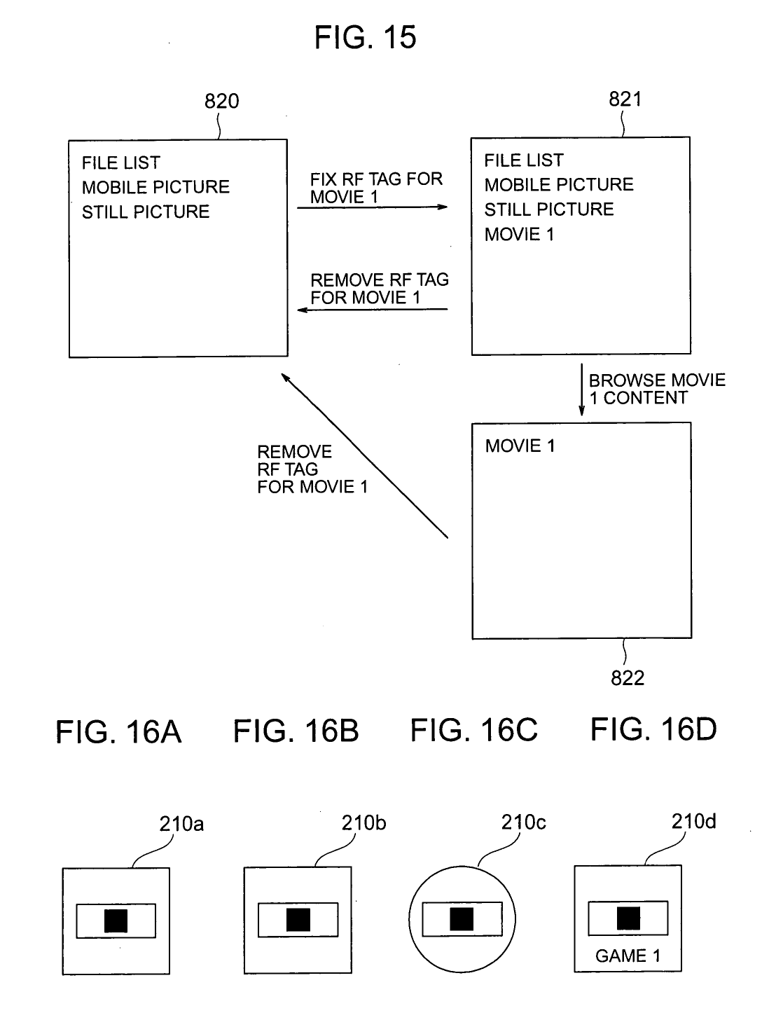

FIG. 15 shows an example in which the service corresponding to the RF tag 200 is browse of contents with a restricted browse count. Numeral 820 is an example of a screen image of a list of contents available before an RF tag 200 is fixed onto the terminal 100. Assume that the service corresponding to an RF tag 200 is browse of “movie 1” with the browse count set to one. When the RF tag 200 is fixed onto the terminal 100, the movie 1 is added to the list of contents available for the user. Numeral 821 shows an example of a screen image of a list contents available after the RF tag 200 is fixed onto the terminal 100. Since the browse count is set to one for the movie 1, the movie 1 is removed from the list of available contents as shown in the screen image 820 after the browse is finished. When the RF tag 200 corresponding to the movie 1 is removed, the movie 1 is also deleted from the list of available contents.

In the service examples, the RF tag 200 is fixed onto the terminal 100 and is thereafter removed therefrom. However, it is naturally possible that the RF tag 200 of card type 220 is inserted into the terminal 100 and is then drawn therefrom.

According to the present invention described above, available services vary depending on RF tags 200. For the user to easily discriminate services, it is possible to advantageously change a color and/or a shape of a seal or a card including the RF tag. Or, characters and letters may be advantageously used for the easy discrimination. This makes users easily discriminate available services. FIGS. 16A to 16D show examples of seals 210 in which the color and/or the shape are/is changed for easy discrimination of services.

It is to be appreciated that this also applies to the card 220.

According to the present invention described above, only by fixing an RF tag onto a terminal, a particular service can be simply installed in the terminal for the user to receive the service. When it is desired to receive a particular service, the user need only fix a particular tag onto a terminal. That is, the user can receive a service through quite a simple operation. When the service becomes no longer necessary, the user need only remove the RF tag. This advantageously improves usability for the user.

According to the present invention, a service can be provided to the user only by distributing an associated RF tag to the user. That is, the service provider can easily provide services to the user.

According to the present invention, the user can easily receive a particular service by use of a terminal, and hence this advantageously improves usability for the user.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A terminal device, comprising:
radio frequency (RF) tag reading means for reading identification information of an RF tag;
communicating means for communicating with a server controlling services;
transmitting means for transmitting by the communicating means the identification information of the RF tag read by the RF tag reading means to the server;
receiving means for receiving, from the server, information regarding a service corresponding to the identification information of the RF tag; and
installing means for installing in the terminal device the service corresponding to the identification information of the RF tag according to the information regarding the service received by the receiving means.

2. A terminal device according to claim 1, wherein when the identification information of the RF tag is disposed at a position at which the identification information can be read by the terminal device, the service corresponding to the RF tag can be used.

3. A terminal device according to claim 1, wherein when the RF tag is fixed on the terminal device in a situation in which the terminal device can read the identification information, the service corresponding to the RF tag can be used.

4. A terminal device according to claim 3, wherein a position of the terminal onto which the RF tag is to be fixed is marked.

5. A terminal device, comprising:
radio frequency (RF) tag reading means for reading identification information of an RF tag;
communicating means for communicating with a server controlling services;
transmitting means for transmitting by the communicating means the identification information of the RF tag read by the RF tag reading means to the server;
receiving means for receiving, from the server, information regarding a service corresponding to the identification information of the RF tag;
installing means for installing in the terminal device the service corresponding to the identification information of the RF tag according to the information regarding the service received by the receiving means; and
service controlling means for controlling a correspondence between the identification information of RF tags and installed services installed in the terminal device, wherein
when identification information of an RF tag cannot be read, the service control means prevents use of a service corresponding to the identification information of the RF tag.

6. A terminal device according to claim 5, wherein when the service information received from the server controlling the service includes error information of an error, the service is not installed.

7. A terminal device according to claim 5, wherein in a case in which the service information received from the server controlling the service includes a restriction regarding a use count of the service, the use of the service is prevented when the restriction of use count is reached.

8. A terminal device, comprising:
radio frequency (RF) tag reading means for reading identification information of an RF tag;
communicating means for communicating with a server controlling services;
transmitting means for transmitting by the communicating means the identification information of the RF tag read by the RF tag reading means to the server;
receiving means for receiving, from the server, information regarding a service corresponding to the identification information of the RF tag; and
installing means for installing in the terminal device the service corresponding to the identification information of the RF tag according to the information regarding the service received by the receiving means, wherein:
when an adhesive sheet including an RF tag is fixed onto the terminal device, a service corresponding to the RF tag can be used; and
when the adhesive sheet including an RF tag is removed from the terminal device, the service corresponding to the RF tag cannot be used.

9. A terminal device, comprising:
radio frequency (RF) tag reading means for reading identification information of an RF tag;
communicating means for communicating with a server controlling services;
transmitting means for transmitting by the communicating means the identification information of the RF tag read by the RF tag reading means to the server;
receiving means for receiving, from the server, information regarding a service corresponding to the identification information of the RF tag; and
installing means for installing in the terminal device the service corresponding to the identification information of the RF tag according to the information regarding the service received by the receiving means, wherein:
when a card including an RF tag is inserted into the terminal device or into a cover thereof, a service corresponding to the RF tag can be used; and
when the card including an RF tag is drawn from the terminal device or from the cover thereof, the service corresponding to the RF tag cannot be used.

10. A service providing server, comprising:
receiving means for receiving identification information of an RF tag from a terminal device;
service control means for controlling a correspondence between identification information of RF tags and services; and
means for transmitting to the terminal device information regarding a service corresponding to the identification information received from the terminal device.

11. A service providing server, comprising:
means for receiving identification information of an RF tag from a terminal device;
service control means for controlling a correspondence between identification information of RF tags and services and information regarding a use count of a service available using identification information corresponding to the service, wherein
in a case in which identification information of an RF tag is received from the terminal device, if a service corresponding to the identification information is absent from the service control means or if the use count of the service available by using the identification information is zero, the server sends particular information to the terminal device to thereby preventing use of the service.

12. An RF tag sheet comprising an RF tag for use in a terminal device capable of reading identification information of the RF tag, wherein:
the identification information of the RF tag of the sheet is sent from the terminal device to a server controlling services;
information regarding a service corresponding to the identification information of the RF tag from the server is received by the terminal;
the service is installed therein; and
the service installed therein can be discriminated by a color of the sheet, a shape of the sheet, characters and letters on the sheet, or a combination thereof.
